(19) United States
(12) Patent Application Publication
(10) Pub. No.: US 2014/0176519 A1
(43) Pub. Date: Jun. 26, 2014

(54) Programmable Gamma Circuit of Liquid Crystal Display Driving System

(71) Applicants: Wei Fu, Shenzhen City (CN); Nianmao Wang, Shenzhen City (CN)

(72) Inventors: Wei Fu, Shenzhen City (CN); Nianmao Wang, Shenzhen City (CN)

(73) Assignee: Shenzhen China Star Optoelectronics Technology Co. Ltd., Shenzhen, Guangdong (CN)

(21) Appl. No.: 13/811,692

(22) PCT Filed: Dec. 28, 2012
(86) PCT No.: PCT/CN12/87754

§ 371 Date: Jan. 23, 2013

(30) Foreign Application Priority Data
Dec. 25, 2012 (CN) 201210571998.1

(51) Int. Cl. G06F 1/26

(52) U.S. Cl. CPC G06F 1/26
USPC 345/211

(57) ABSTRACT

A programmable gamma circuit of liquid crystal display driving system, comprises: a first digital-to-analog converter to a n-th digital-to-analog converter, which receive a data used to generate a reference voltage of a pixel grayscale from a timing controller of the liquid crystal display driving system and convert the data to an analog signal; a first operational amplifier to a n-th operational amplifier, each operational amplifier being connected to a corresponding digital-to-analog converter, the amplified analog signal being the reference voltage of the pixel grayscale ; a first resistor to a fifth resistor, which are connected in series with each other, the operating voltage obtained by a voltage converter of the liquid crystal display driving system converting the reference voltage being input to one end of the first resistor, and one end of the fifth resistor being grounded. The voltage between the first resistor and the second resistor is input respectively to the power supply terminals of the first n/2 operational amplifiers, the voltage between the second resistor and the third resistor is input respectively to the ground terminals of the first n/2 operational amplifiers, the voltage between the third resistor and the fourth resistor is input respectively to the power supply terminals of the last n/2 operational amplifier, and the voltage between the fourth resistor and the fifth resistor is input respectively to the ground terminals of the last n/2 operational amplifier.

### BACKGROUND OF THE INVENTION

1. Field of the Invention

The present invention belongs to the field of liquid crystal display, which relates to a programmable gamma circuit of a liquid crystal display reducing the power consumption and the temperature.

2. The Related Arts

The driving system of the known liquid crystal display (LCD) typically comprises a programmable Gamma (P-Gamma) circuit. The P-Gamma circuit generates a pixel grayscale voltage reference (Gamma voltage). The pixel grayscale reference voltage can be supplied to the gate driver in order to drive each pixels of the liquid crystal display panel.

FIG. 1 is a partial block diagram of the driving system according to the known LCD. Referring to FIG. 1, the interface logic 1 of a inter integrated circuit (12C) receives serial clock (SCL) signal, serial data (SDA) and writing enable signal (nWR), and supplies the received signals and the data to a timing controller 2. The timing controller 2 generates a timing control signal and a data used to generate the reference voltage of the pixel grayscale. P-Gamma circuit 3 comprises multiple digital-to-analog converters (DAC) and multiple OPs, each DAC is connected to a corresponding OP. DAC receives the data used to generate the reference voltage of the pixel grayscale from the timing controller 2, and converts the data to a analog signal. The analog signals amplified and converted from the OP act as the reference voltages Vₒᵤₜ₁ Vₒᵤₜ₂ of . . . , Vₒᵤₜₙ (FIG. 1 shows the situation that the n is 14) of the pixel grayscale. The timing controller 2 controls the timing of the reference voltage of the pixel grayscale generated by each OP according to the timing control signal. Moreover, the deflecting reference voltage of the liquid crystal molecules (V_{com}) module 4 generates the deflecting reference voltage V_{com out} of the liquid crystal molecules according to the timing controller 2.

Typically, the working voltage of the OP in the P-Gamma circuit is V_{AA}/0 (V_{AA} is the operating voltage converted from the reference voltage by the voltage converter of the LCD driving system). The voltage difference of the OP is larger, and the power consumption P of the OP=V (voltage)×I (current), so that the power consumption of OP is larger, the power consumption of the corresponding P-Gamma circuit will be larger, and the temperature of the P-Gamma circuit is also higher, which will reduce the performance of the P-Gamma circuit and decrease the life of the P-Gamma circuit.

### SUMMARY OF THE INVENTION

According to an aspect of the present invention, it provides a programmable gamma circuit of liquid crystal display driving system, comprising: a first digital-to-analog converter to a n-th digital-to-analog converter, which receive a data used to generate a reference voltage of a pixel grayscale from a timing controller of the liquid crystal display driving system and convert the data to an analog signal; a first operational amplifier to a n-th operational amplifier, each operational amplifier being connected to a corresponding digital-to-analog converter within the first digital-to-analog converter to the n-th digital-to-analog converter, the analog signal converted by the first operational amplifier converter to the n-th operational amplifier converter being the reference voltage of the pixel grayscale Vₒᵤₜ₁ to Vₒᵤₜₙ, wherein, n is even; a first resistor to a fifth resistor, which are connected in series with each other, the operating voltage V_{AA} obtained by a voltage converter of the liquid crystal display driving system converting the reference voltage being input to one end of the first resistor, and one end of the fifth resistor being grounded; wherein, the voltage V_{AA}, between the first resistor and the second resistor is input respectively to the power supply terminals of the first n/2 operational amplifiers, the voltage V_{AA2} between the second resistor and the third resistor is input respectively to the ground terminals of the first n/2 operational amplifiers, the voltage V_{AA3} between the third resistor and the fourth resistor is input respectively to the power supply terminals of the last n/2 operational amplifier, and the voltage V_{AA4} between the fourth resistor and the fifth resistor is input respectively to the ground terminals of the last n/2 operational amplifier.

The voltage V_{AA1} between the first resistor and the second resistor is greater than the reference voltage Vₒᵤₜ₁ of the pixel grayscale output from the first operational amplifier, the voltage V_{AA2} between the second resistor and the third resistor is less than the reference voltage V_{out(n/2-1)} output from the pixel grayscale of the (n/2−1)-th operational amplifier, the voltage V_{AA3} between the third resistor and the fourth resistor is greater than the reference voltage Vout(n/2−1) of the pixel grayscale output from the (n/2−1)-th operational amplifier, the voltage V_{AA4} between the fourth resistor and a fifth resistor is less than the reference voltage Vₒᵤₜₙ output from the pixel grayscale of the n-th operational amplifier.

The resistances R₁ to R₅ of the first resistor to the fifth resistor satisfy the equation: V_{AA}/(R₁+R₂+R₃+R₄+R₅)=V_{AA1}/(R₂+R₃+R₄+R₅) =V_{AA2}/(R₃+R₄+R₅)=V_{AA3}/(R₄+R₅)=V_{AA4}/R₅, determine the values of the voltage V_{AA1} to V_{AA4} according to the values of the predetermined reference voltage Vₒᵤₜ₁ to Vₒᵤₜₙ of the pixel grayscale, then select the resistance R₅ of the fifth resistor, and calculate the resistances R₁ to R₄ of the first resistor to the fourth resistor according to the equation.

### BRIEF DESCRIPTION OF THE DRAWINGS

From the following description of the embodiments accompanying with the drawings, the present invention and/or other aspects and advantages will become apparent and more easy to be understood, wherein:

FIG. 1 is a partial block diagram of the driving system according to the known LCD;

FIG. 2 is a schematic view illustrating a P-Gamma circuit of the driving system of the LCD according to the first embodiment of the present invention; and

FIG. 3 is a block diagram of the P-Gamma circuit of the driving system of the LCD according to the second embodiment of the present invention.

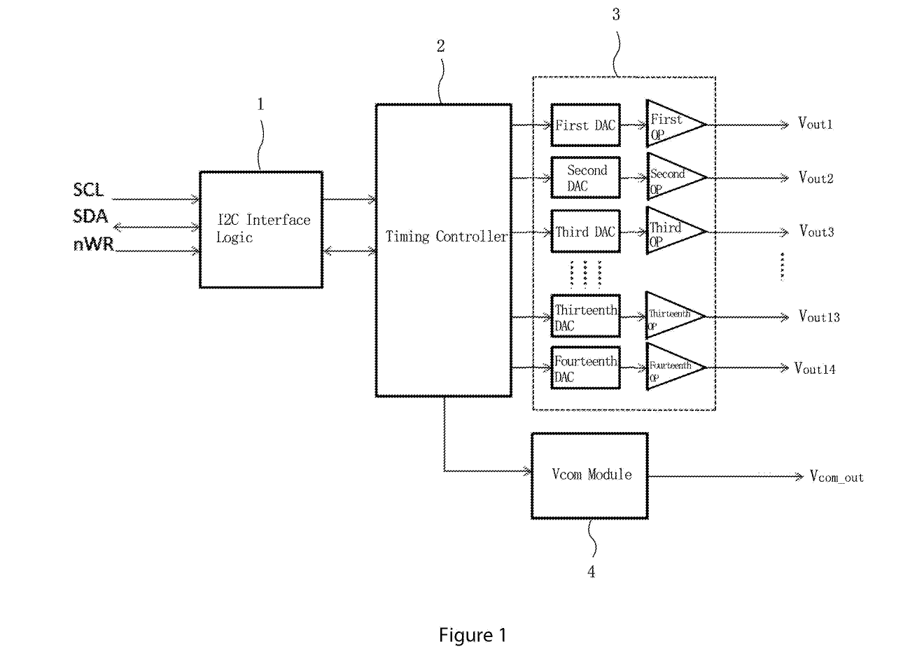

### DETAILED DESCRIPTION OF THE PREFERRED EMBODIMENTS

The following embodiment of the present invention will be described in detail accompanying with the drawings.

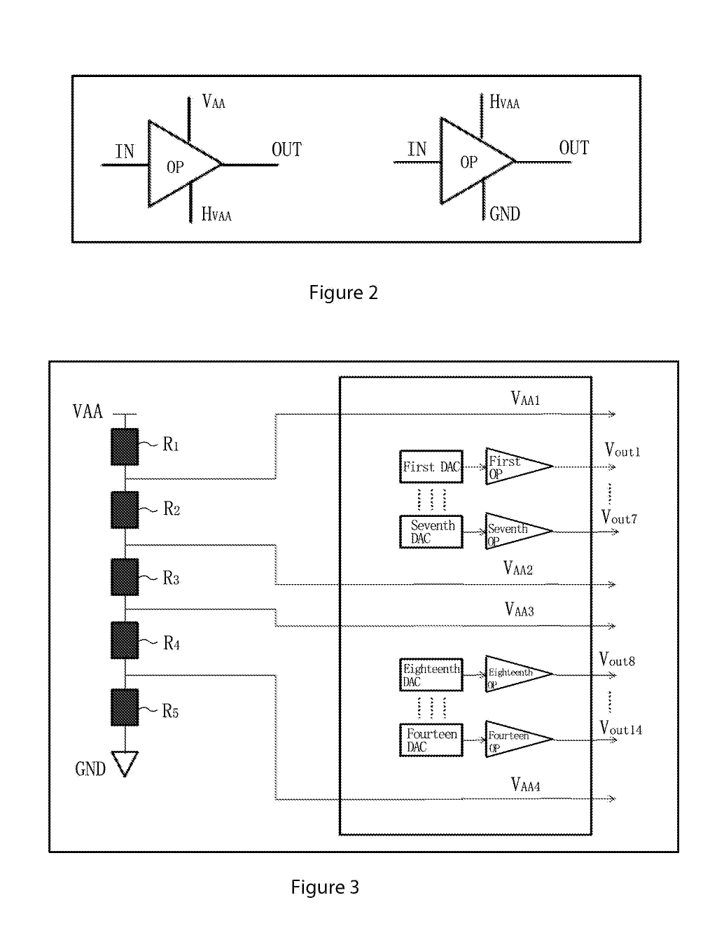

FIG. 2 is a schematic view illustrating a P-Gamma circuit of the driving system of the LCD according to the first embodiment of the present invention.

Referring to FIG. 2, in the first embodiment of the present invention, import the half of the operating voltage V_{AA} (HV_{AA}) converted from the reference voltage by the voltage converter of the LCD driving system as the working voltage of the OP in P-Gamma circuit.

Specifically, P-Gamma circuit comprises the first DAC to the n-th DAC and the first OP to the n-th OP, wherein n is even (see FIG. 3). Each DAC is connected to a corresponding OP. Each OP is connected to a corresponding DAC. The DAC receives the data used to generate the reference voltage of the pixel grayscale from the timing controller of the LCD driving system, and converts the data to an analog signal. The analog signal amplified and converted by the OP is used for the reference voltages of the pixel grayscale Vₒᵤₜ₁, Vₒᵤₜ₂, . . . , Vₒᵤₜₙ.

Divide the n OPs into two groups of first n/2 OPs and last n/2 OPs. The following takes n equal to 14 as an example to describe the first embodiment of the present invention. The present invention is not limited thereto, and the size of the n can be changed according to the requirement. Divide the 14 OPs into two groups of the first 7 OPs and the last 7 OPs. Import the half of the operating voltage V_{AA} (HV_{AA}) converted from the reference voltage by the voltage converter of the LCD driving system. The operating voltage V_{AA} is input respectively to the power supply terminals of the first 7 OPs, and the half of operating voltage V_{AA} (HV_{AA}) is input respectively to the ground terminal of the first 7 OPs; similarly, the half of operating voltage V_{AA} (HV_{AA}) is input respectively to the power supply terminals of the other 7 OPs, and the ground terminals of the last 7 OPs are grounded (i.e. the voltage is 0).

Therefore, the working voltage across the OP is only half of the working voltage according to the known technologies. The current flowing through the OP is decided by the load connected to the OP backend. If the load is same, the current flowing through the OP will not be changed. According to power consumption P=V×I, in theory, the power consumption of each OP will be reduced by half, and the temperature will be reduced. Therefore, the power consumption of the P_Gamma circuit will be reduced, and the temperature will be reduced.

It can directly generate half the operating voltage V_{AA} (HV_{AA}) through the voltage converter of the LCD driving system, or it can generate half the operating voltage V_{AA} (HV_{AA}) through connecting two identical voltage-dividing resistors in series.

FIG. 3 is a block diagram of the P-Gamma circuit of the driving system of the LCD according to the second embodiment of the present invention.

Referring to FIG. 3, the P-Gamma circuit comprises the first DAC converter to the n-th DAC and the first OP to the n-th OP, wherein n is even. Each DAV is connected to a corresponding OP. Each OP is connected to a corresponding DAC. The first DAC to the n-th DAC receive the data used to generate the reference voltage of the pixel grayscale from the timing controller of the LCD driving system, and convert the data to an analog signal. The analog signal amplified and converted by OP is used for the reference voltage of the pixel grayscale Vₒᵤₜ₁, Vₒᵤₜ₂. . . , Vₒᵤₜₙ.

Divide the n OPs into two groups of first n/2 OPs and last n/2 OPs. The following takes n equal to 14 as an example to describe the second embodiment of the present invention. The present invention is not limited thereto, and the size of the n can be changed according to the requirement. Divide the 14 OPs into two groups of the first 7 OPs and the last 7 OPs.

In the second embodiment of the present invention, import the first resistor R₁ to the fifth resistor R₅ to divide the operating voltage V_{AA}.

Specifically, the first resistor R₁ to the fifth resistor R₅ are connected with each other in series, the operating voltage V_{AA} is input to one end of the first resistor R₁, and one end of the fifth resistor R₅ is grounded.

The voltage V_{AA1} between the first resistor R₁ and second resistor R₂ is respectively input to the power supply terminals of the first 7 OP, the voltage V_{AA2} between the second resistor R₂ and the third resistor R₃ is respectively input to the ground terminals of the first 7 OP, the voltage V_{AA3} between the third resistor R₃ and the fourth resistor R₄ is respectively input to the power supply terminals of the last 7 OP, the voltage V_{AA4} between the fourth resistor R4 and the fifth resistor R5 is respectively input to the ground terminals of the last 7 OP. In this way, the voltage differences of the first 7 OP are V_{AA1}−V_{AA2}, the voltage differences of the last 7 OP are V_{AA3}−V_{AA4}, both (V_{AA1}−V_{AA2}) and (V_{AA3}−V_{AA4}) are less than V_{AA}.

The operating voltages of each OP are couple, one is high and the other one is low, the output voltage Vₒᵤₜ of the OP is provided within the working voltages of the OPs. Therefore, V_{AA1}>Vₒᵤₜ₁, V_{AA2}<Vₒᵤₜ₇, V_{AA3}>Vₒᵤₜ₈, V_{AA4}<Vₒᵤₜ₁₄. In the case of the n OP, it is similar to obtain V_{AA1}>Vₒᵤₜ₁, V_{AA2}<V_{out(n/2-1)}, V_{AA3}>V_{out(n/2+1), V}_{AA4}<Vₒᵤₜₙ.

According to the relationship of the first resistor R₁ to the fifth resistor R₅ connected in series to each other, it can be known that V_{AA}/(R₁ +R₂+R₃+R₄+R₅)=V_{AA1}/(R₂+R₃+R₄+R₅)=V_{AA2}/(R₃+R₄+R₅)=V_{AA3}/(R₄+R₅)=V_{AA4}/R₅. Here it also uses R₁ to R₅ to represent the resistances of the first resistor to the fifth resistor.

Therefore, it can determine the value of V_{AA1} to V_{AA4} according to each required reference voltage of the pixel grayscale Vₒᵤₜ₁, Vₒᵤₜ₂, . . . , Vₒᵤₜ₁₄, and then select the resistance of the fifth resistor R₅, and it can calculate the resistances of the first resistor to the fourth resistor according to the above equation.

As mentioned above, the current flowing through the OP is decided by the load connected to OP backend. If load is same, the current flowing through the OP will not be changed. According to power consumption P=V×I, if V is reduced, in theory, the power consumption on each OP will be reduced, and the temperature will be reduced. Thus, the power consumption of P_Gamma circuit will be reduced, and the temperature will be reduced. Accordingly, it can maintain the performance of the P-Gamma circuit and prolong the life of the P-Gamma circuit.

The present invention referring to the exemplary embodiment is specifically described and illuminated, but those having ordinary skills in the art should understand that it can changed in various forms and details without departing from the spirit and scope of the claim defined by the present invention.

What is claimed is:

1. A programmable gamma circuit of liquid crystal display driving system, comprising:
a first digital-to-analog converter to a n-th digital-to-analog converter, which receive a data used to generate a reference voltage of a pixel grayscale from a timing controller of the liquid crystal display driving system and convert the data to an analog signal;
a first operational amplifier to a n-th operational amplifier, each operational amplifier being connected to a corresponding digital-to-analog converter within the first digital-to-analog converter to the n-th digital-to-analog converter, the analog signal converted by the first operational amplifier converter to the n-th operational amplifier converter being the reference voltage of the pixel grayscale Vₒᵤₜ₁ to Vₒᵤₜₙ, wherein, n is even;
a first resistor to a fifth resistor, which are connected in series with each other, the operating voltage V_{AA} obtained by a voltage converter of the liquid crystal display driving system converting the reference voltage being input to one end of the first resistor, and one end of the fifth resistor being grounded;
wherein, the voltage V_{AA1} between the first resistor and the second resistor is input respectively to the power supply terminals of the first n/2 operational amplifiers, the voltage V_{AA2} between the second resistor and the third resistor is input respectively to the ground terminals of the first n/2 operational amplifiers, the voltage V_{AA3} between the third resistor and the fourth resistor is input respectively to the power supply terminals of the last n/2 operational amplifier, and the voltage V_{AA4} between the fourth resistor and the fifth resistor is input respectively to the ground terminals of the last n/2 operational amplifier.

2. The programmable gamma circuit as claimed in claim 1, wherein the voltage V_{AA1} between the first resistor and the second resistor is greater than the reference voltage Vₒᵤₜ₁ of the pixel grayscale output from the first operational amplifier, the voltage V_{AA2} between the second resistor and the third resistor is less than the reference voltage V_{out(n/2-1)} output from the pixel grayscale of the (n/2−1)-th operational amplifier, the voltage V_{AA3} between the third resistor and the fourth resistor is greater than the reference voltage V_{out(n/2-1)} of the pixel grayscale output from the (n/2−1)-th operational amplifier, the voltage V_{AA4} between the fourth resistor and a fifth resistor is less than the reference voltage Vₒᵤₜₙ output from the pixel grayscale of the n-th operational amplifier.

3. The programmable gamma circuit as claimed in claim 1, wherein the resistances R₁ to R₅ of the first resistor to the fifth resistor satisfy the equation: V_{AA}/(R₁+R₂+R₃+R₄+R₅)=V_{AA1}/(R₂+R₃+R₄+R₅)=V_{AA2}/(R₃+R₄+R₅)=V_{AA3}/(R₄+R₅)=V_{AA4}/R₅,
determine the values of the voltage V_{AA1} to V_{AA4} according to the values of the predetermined reference voltage Vₒᵤₜ₁ to Vₒᵤₜₙ of the pixel grayscale, then select the resistance R5 of the fifth resistor, and calculate the resistances R1 to R4 of the first resistor to the fourth resistor according to the equation.
